(19) United States
(12) Patent Application Publication
(10) Pub. No.: US 2012/0006427 A1
(43) Pub. Date: Jan. 12, 2012

(54) Hydraulic Valve Device

(76) Inventor: Rüb Winfried, Waldshut-Tiengen (DE)

(21) Appl. No.: 13/138,593

(22) PCT Filed: Feb. 9, 2010
(86) PCT No.: PCT/EP2010/000777

§ 371 Date: Sep. 23, 2011

(30) Foreign Application Priority Data
Mar. 27, 2009 (DE) 10 2009 015 384.5

(51) Int. Cl. F16K 31/36

(52) U.S. Cl. 137/489

(57) ABSTRACT

The invention relates to a hydraulic valve device having a fluid connection arrangement (10) and having a displaceable control device (16) for at least partially actuating connections of the fluid connection arrangement (10), wherein the control device (16) can be actuated by two opposing pilot valves and is held in the neutral position thereof by centering springs. By providing at least one throttle position (da₁, db₁) between each pilot valve and the control device that can be connected for fluid flow between a load probe connection (LF_{A}) and a load indicating connection (LM_{A}) or a load probe connection (LF_{B}), a hydraulic valve device enables fine control for moving loads.

The invention relates to a hydraulic valve device having a fluid connection arrangement comprising at least
one pressure supply connection P,
one return connection R,
one load sensing connection LS,
two control connections P_{A}′ and P_{B}′, and
two user connections A, B
   and having a movable control device for at least partial actuation of connections of the fluid connection arrangement, the control device being actuatable by two oppositely acting pilot valves and being held spring-centered in its neutral position.

EP 1 616 997 A1 discloses a hydraulic control arrangement for actuation of a hydraulic consumer, especially in the form of a mobile machine, this consumer being connectable by means of a continuously adjustable directional valve arrangement via an inlet to a pump and via an outlet to a tank, where a continuously adjustable directional valve of the directional valve arrangement in a base position opens a circulation channel via which the pump is connected to the tank and in which there is a circulation compensator. In the control positions of the directional valve, the circulation channel can be closed and an inlet line for hydraulic fluid supply of the consumer can be opened. Since, in the known solution, the directional valve arrangement has an outlet throttle valve which is located in the outlet and whose opening cross section can be adjusted independently of the actuation of the directional valve, a type of separate outlet groove is formed which can be suitably actuated independently of the intake cross section depending on the prevailing operating conditions. Thus, for example, a pressure for preloading the consumer can be set in the outlet via the outlet throttle valve. Furthermore, the volumetric flow can be specified, for example, via the intake, and then the speed of the consumer can be adjusted by setting the outlet throttle valve.

DE 38 02 672 C2 discloses a generic hydraulic valve device having a pressure sensing device in which there is a spool as a movable control device in a housing bore, which spool can be moved out of a neutral position into two operating positions, the spool having a central land section and two end lands which are separated therefrom by one spool ring groove each and the indicated lands on the facing sides having throttle profilings which are limited to peripheral sections. The housing bore has a pump ring groove which can be supplied with a pressurizing medium, and to whose two sides there is one motor ring groove each which can be connected to a motor line and to two sides outside thereof there is one container ring groove each which can be connected to the container. The pressure sensing device has at least one pressure sensing opening which is connected via a connecting channel in the spool to a pressure sensing connection, which is located on the spool periphery opposite the throttle profilings, offset in the peripheral direction, and which in the operating position of the spool is connected to the pressure-conducting lines to be sensed, but which is separated from it in the neutral position. Since there is at least one of the pressure sensing openings in the central land section for ascertaining the input pressure in the pump ring groove—in the connecting channel within the spool, there being a fixed throttle and on the outside of the spool between a sensing pressure ring groove and the container ring groove in the housing bore, there being a variable throttle which depends on the spool position—a smaller dead path of the spool between the neutral position and the operating position is enabled; this leads to an overall valve device that is compact in size.

Proceeding from this prior art, the object of the invention is to devise a hydraulic valve device with which fine control is possible until the load, connected to the respective user connection, actually moves. This object is achieved by a hydraulic valve device with the features of claim 1 in its entirety.

In that, as specified in the characterizing part of claim 1, between the respective pilot valve and the control device there is at least one throttle point which is connected to a load detecting connection LF_{A} and to a load indicating connection LM_{A} or a load detecting connection LF_{B} and to a load indicating connection LM_{B} to conduct fluid, the result is that a definable actuation pressure on the movable control device, made preferably in the form of a valve spool, is opposed by a compensation pressure which is derived from the actual load pressure and which keeps the control device in the fine control range until the load connected to the user connections A, B moves. Then the control device can pass into a position which is open so wide that it allows the counterpressure from the accelerating load, with the leakage flow being increasingly shut off. When the leakage flow is completely shut off, a volume control, which is present as is typical for loading sensing valves, is implemented and the pressure control is shut off. The pressure control and the volumetric flow control are superimposed in this transition region.

In one preferred embodiment of the valve device according to the invention, the control device in the form of a valve spool has fluid-conducting connecting channels which connect to one another the load sensing and load indicating connections which can be assigned in pairs to one another. Preferably, one of the connecting channels is made in an especially space-saving manner as a central channel which is connected to one of the throttle points, the other throttle point discharging into an annular channel which, arranged coaxially to the central channel, is bordered by an inner recess of the valve spool and an insert sleeve through which the central channel extends.

In another preferred embodiment of the solution according to the invention, the control device is connected downstream of a compensator with which the so-called flow rate cutoff is facilitated by a load sensing pressure limitation in the spring chamber of the compensator. In the solutions known in the prior art with a downstream compensator, this function of the flow rate cutoff is not possible or can be obtained only via corresponding valve accessory structures in a complex manner. In particular, the control function of the compensator is improved by a relatively large drain cross section being able to discharge into the return connection. In this respect, a so-called float position for the entire arrangement is also improved.

The hydraulic valve device according to the invention is detailed below using one exemplary embodiment as shown in the drawings. The figures are schematic and not to scale.

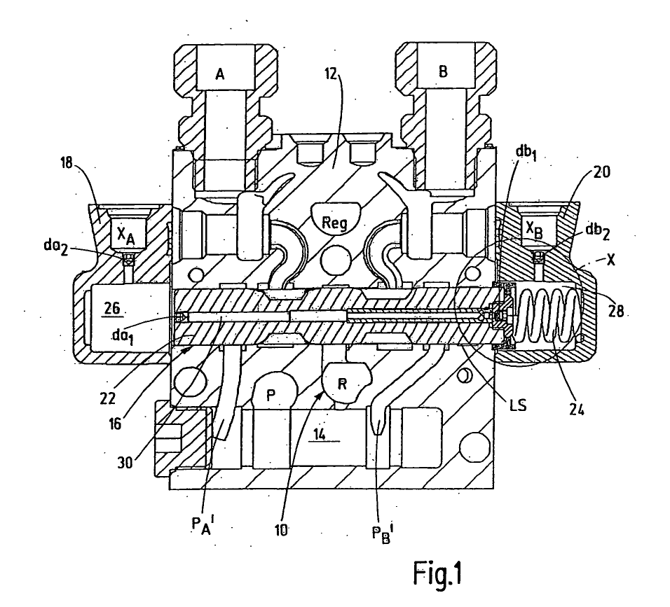

FIG. 1 shows as a longitudinal section a front-side plan view of the essential components of the valve device, but without pilot valves inserted;

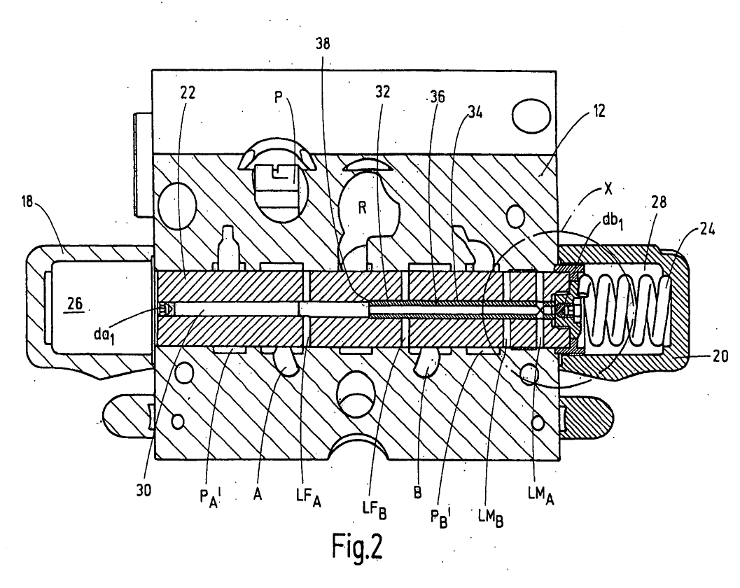

FIG. 2 shows as a longitudinal section a cutaway bottom view of the article according to FIG. 1;

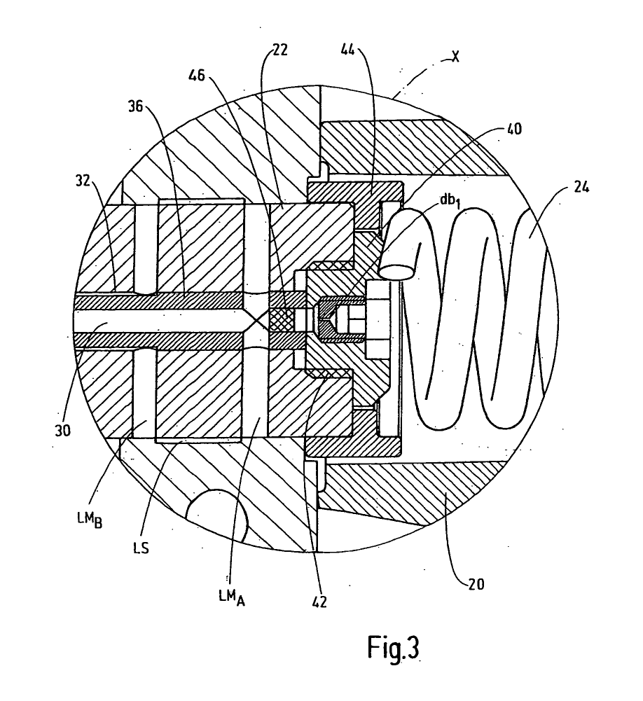

FIG. 3 shows an enlargement of the extract circle X according to FIG. 2;

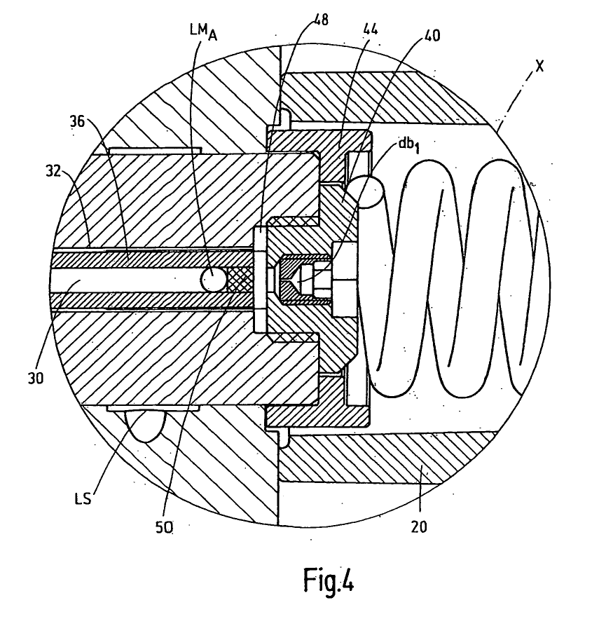

FIG. 4 shows an enlargement of the extract circle X according to FIG. 1.

FIG. 1 shows a fluid connection arrangement which is designated as a whole as 10. This fluid connection arrangement 10 has one pressure supply connection P, one return connection R, one load sensing connection LS, two control connections P_{A}′ and P_{B}′, and two user connections A, B. The indicated fluid connections P_{A}′, P, R, P_{B}′, and LS, viewed in the direction of looking at FIG. 1 from left to right, and the user connections A and B are accommodated in a control housing 12, where, viewed in the direction of looking at FIG. 1, the bottom end of the control housing 12 is provided with a conventional compensator 14 whose mechanical structure will not be further detailed. The compensator 14, however, is connected upstream of the connections P_{A}′ and P_{B}′, and actuates the control connections P_{A}′, P_{B}′, according to the stipulation of the prevailing LS signal. With the upstream compensator 14, the function of a so-called flow rate cutoff by an LS pressure limitation in the so-called spring chamber (not shown) of the compensator is attained, and flow rate cutoff can be a good idea, for example, when a steering cylinder connected to the user connections A, B is on the stop and the intake flow rate is to be “cut off” to prevent overloads.

The control device which is designated as a whole as 16 as such is actuated by conventional pilot valves in a known manner which therefore will not be further detailed; said valves, for the sake of simplicity, are shown in FIG. 1 only to the extent that their respectively assignable pilot connection housings 18, 20 are addressed. On the output side, the two pilot valves, however, deliver two oppositely acting control pressures X_{A} and X_{B} for the control device 18.

The indicated control device 16 has a valve spool 22 which can be moved horizontally, viewed in the direction of looking at FIG. 1, and which is shown in FIG. 1 in its undeflected central or neutral position. This neutral position of the valve spool 22 is supported by two spring energy storage mechanisms which are designed as compression springs 24 and are integrated in a respectively assignable spring chamber 26, 28 in the assignable pilot connection housings 18 and 20. For the sake of simplicity, viewed in the direction of looking at FIG. 1, the compression spring 24 was not depicted for the left spring chamber 26. This structure is also known for such hydraulic valve devices so that it will not be further detailed here.

The control device 16 with valve spool 22 is provided with load detecting connections LF_{A} and LF_{B} and with load indicating connections LM_{A} and LM_{B} which are connected in pairs to one another to conduct fluid. As shown especially by the bottom view from FIG. 1 to FIG. 2, the load detecting connection LF_{A} is connected to the load indicating connection LM_{A} and the load detecting connection LF_{B} to the load indicating connection LM_{B}. These detecting connections and indicating connections, with the latter also being referred to as signal lines in the technical jargon, are made in the valve spool 22 in the form of radial transverse bores and, depending on which axial travel position is assumed by the valve spool 22, the indicated load detecting and load indicating connections are connected to the respectively assignable connections of the fluid connection arrangement 10 to conduct fluid or to block fluid. In particular, the load detecting and load indicating connections are connected to one another in an assignable manner via fluid-conducting connecting channels within the valve spool 22. Thus, one of the connecting channels is made as a central channel 30, which, along the central or displacement longitudinal axis of the valve spool 22, completely penetrates it and discharges into the open to both ends. This central channel 30 connects the load detecting connection LF_{A} to the load indicating connection LM_{A} to conduct fluid. Coaxially to the central channel 30, there is furthermore an annular channel 32 whose right-hand structural configuration is shown especially in FIGS. 3 and 4. This annular channel 32 is made in an inner recess 34 of the valve spool 22 as a radial bore and is bordered to the inside by the cylindrical outer periphery of an insert sleeve 36 which, designed as hollow cylinder, routes part of the central channel 30. Viewed in the direction of looking at FIG. 2, the insert sleeve 36 with its left end side is supported on an added radial shoulder 38 in the valve spool 22.

As follows furthermore from FIGS. 1 and 2, in the direction of looking at them, on the left side a first throttle point da₁ is made and via the left face-side end of the valve spool 22 engages a portion of the central channel 30. As a counterpart on the opposite side, a second throttle point db₁ is made whose configuration is shown especially in FIGS. 3 and 4. This throttle point db₁ is integrated in a sealing screw 40 which is screwed into a face-shaped recess of the valve spool 22 via a thread section 42. On the outer peripheral side, a type of valve disk 44 extends over this sealing screw 40 and, under the action of the compression spring 24, viewed in the direction of looking at FIGS. 3 and 4, is moved into the neutral position until the valve disk 44 with its outside edge ends flush with the end side of the control housing 12, as shown in FIGS. 3 and 4.

In the extract as shown in FIG. 3, which corresponds to the enlargement of the circle X in FIG. 2, the insert sleeve 36 is routed so far out of the valve spool 22 to the right that the free face-side end of the insert sleeve 36 makes contact with the outer end wall surface of the sealing screw 40. Leaving the radial or transverse bore open as the load indicating connection LM_{A}, the remaining central channel 30 in the direction of the throttle point db, is closed fluid-tight with a stop plug 46. This ensures that the load sensing pressure of the load detecting connection LF_{A} relayed via the central channel 30 cannot reach the second throttle point db₁. As illustrated by the longitudinal section turned by 90° relative thereto as shown in FIG. 4, the throttle point db₁ discharges into the annular channel 32 via the connecting channel 48 in the form of a cylindrical widening in the valve spool 22, so that in this respect there is a fluid-conducting connection between the load detecting connection LF_{B} and the load indicating connection LM_{B}. These connections in turn do not have a connection to the throttle point da₁, and FIG. 4 corresponds to FIG. 1 in terms of the enlarged circle representation X. To block the central channel 30 relative to the connecting channel 48, another fluid-tight stop plug 50 is used; it is located between the load indicating connection LM_{A} and the connecting channel 48 within the insert sleeve 36.

If at this point, viewed in the direction of looking at FIGS. 1 to 4, the valve spool 22 is moved out of its neutral position into a left-hand operating position, the load detecting connection LF_{A} overlaps the user connection A and the pressure prevailing there and can relay the latter via the central channel 30 and the load indicating connection A to the load sensing connection LS, likewise made as an annular channel, since in this respect the load indicating connection LM_{A} travels into the LS annular channel. In the opposite case, that is, when the valve spool 22 is moving from its central position to the right, the load detecting connection LF_{B} moves into the assigned user connection B and the pressure which has been detected there via the annular channel 32 travels via the load indicating connection B into the annular channel with the load sensing connection LS. This load sensing and indicating chain is then superimposed on the prevailing pilot valve sensor pressure which prevails on the throttles da₁ and db₁. As FIG. 1 exclusively shows, a third and fourth throttle point da₁ and db₂ can additionally be made between the respectively inserted pilot valve and the spring chamber 26 and 28. To the extent the throttle point is addressed below, it can be implemented via a conventional throttle, but also via a diaphragm.

The specific structure of the hydraulic valve device according to the invention is detailed below in the manner of a functional description.

In the neutral position as shown in FIG. 1, the pressure connection P and the user connections A and B are blocked off from one another, and such an execution can also be referred to as the closed central position. Furthermore, the load sensing line is connected to the return R, that is, it is relieved. Two other signal lines in the form of the load indicating connection LM_{A} and of the load indicating connection LM_{B} are connected to the load sensing connection LS. In the illustrated neutral position, the two signal lines are connected to LS, in the operating positions always the one which leads to the unpressurized pilot pressure space. The pilot pressure space here is identical to the respective spring chamber in the form of the spring chambers 26, 28. If in the neutral position a sensor pressure (=actuation pressure) X_{B}, X_{A} is activated, a control oil stream flows briefly via the throttle db₂ and db₁ and the signal line LM_{B} via the load detecting connection LF_{B} to the return connection R until the pressure which is building up in the second spring chamber 28 (X_{B} side) shifts the valve spool 22 into an intermediate position. Then this signal line is blocked and there is no control oil loss. This intermediate position constitutes the so-called fine control range. The connection from the pressure supply connection P to the user connection A at this point is only slightly open. The signal line LM_{A} is in turn separated by the throttle da₁ from the spring chamber 26 and the spring chamber 26 from the sensor pressure connection X_{A} (X_{B}) by the throttle da₂. Since in the described state (X_{B} is activated) the sensor connection X_{A} is unpressurized, the pressurized medium can press from the load via the LS connection into the signal line connected in parallel and from there as a signal flow can drain via the throttles da₁ and da₂ into the unpressurized connection X_{A}. The load pressure is essentially reduced in two stages, from “LS” to “pressure” in the spring chamber 26 on the throttle da₁ and from there to “X_{B}=Tₒ=0” via the throttle da₂. The resulting intermediate pressure in the spring chamber 26 then opposes the actuating sensor pressure X_{B}. The valve spool position is thus determined by the difference of the sensor pressure X_{B} and the intermediate pressure X′_{A} in the spring chamber 26 on the connection X_{A}.

Therefore, on the one hand, a signal current flows into the spring chamber 26 at X_{A} in the intermediate position of the fine control range and moves the valve spool 22 in the “neutral” direction in proportion to the load pressure, and, on the other hand, a leakage flow travels from the working connection A to the return connection R. If the consumer A is at rest, in the connection A a pressure is established which is determined by the series connection of the connection from P to A and of the variable orifice to the return connection R. Thus a control circuit is formed which is actuated by the sensor pressure X_{B}. With the consumer at rest, the artificial load which is building up is lower than the pump pressure on the pressure supply connection P by the amount of the controlled pressure difference of the upstream compensator 14. The pump is therefore actuated as is typical in load sensing systems. The artificial load sensing pressure also reacts on the valve spool 22 via the above-described signal line and the connected throttles da₁ and db₁, and the valve spool 22 regulates the pressure in the user connection A by its position and series connection (pressure divider circuit) of the adjustable connection between P and user connection A as well as the variable orifice to the return connection R. The leakage flow can be mechanically adjusted around the stability of the pressure regulation by the size of the variable orifice which is used at the time and which depends on the spool stroke.

If the sensor pressure is raised further, the spool 22 is adjusted out of its fine control range, the throttled pressure rises, and the load is moved accordingly. With further adjustment, the variable orifice can be shut off to the return connection R because at this point the acceleration phase is ended and the constant travel of the load is attained. The sensor pressure X_{B} then dictates how much volumetric flow may be supplied to the consumer so that the back pressure which is being established in A is not exceeded.

With the hydraulic valve device according to the invention, it is therefore possible to use the fine control range of the valve spool 22 in order to regulate the pressure by means of a leakage flow. In this way, the actuating pressure on the valve spool 22 is opposed by a compensation pressure derived from the actual load pressure, and the compensation pressure keeps the valve spool 22 in the fine control range until the load connected to the user connections A, B is moving. In this way, leakage flows can be increasingly shut off, and with complete shutoff a volumetric flow control is implemented, as is conventional in LS valves. The pressure control is then shut off, pressure and volume control being superimposed in the transition region.

1. A hydraulic valve device having a fluid connection arrangement (10) comprising at least
one pressure supply connection (P),
one return connection (R),
one load sensing connection (LS),
two control connections (PA′ and PB′) and
two user connections (A, B) and
having a movable control device (16) for at least partial actuation of connections of the fluid connection arrangement (10), the control device (16) being actuatable by two oppositely acting pilot valves and being held spring-centered in its neutral position, characterized in that between the respective pilot valve and the control device there is at least one throttle point (da1, da2) which is connected to a load detecting connection (LFA) and to a load indicating connection (LMA) or a load detecting connection (LFB) as well as to a load indicating connection (LMB) to conduct fluid.

2. The valve device according to claim 1, characterized in that the control device (16) has a valve spool (22) with fluid-conducting connecting channels which connect to one another the load sensing and load indicating connections (LFA, LMA; LFB, LMB) which can be assigned in pairs to one another.

3. The valve device according to claim 2, characterized in that one of the connecting channels is made as a central channel (30) which is connected to one of the throttle points (da1) and that the other throttle point (db1) discharges into an annular channel (32) which, arranged coaxially to the central channel (30), is bordered by an inner recess (34) of the valve spool (22) and an insert sleeve (36) through which the central channel (30) extends.

4. The valve device according to claim 3, characterized in that in the spring-centered neutral position of the valve spool (22) the two load detecting connections (LFA, LFB) are outside the annular channels with the user connections (A, B), and the annular channel of the load sensing connection (LS) is located between the assignable load indicating connections (LMA, LMB).

5. The valve device according to claim 3, characterized in that the throttle point (da1) is connected via the central channel (30) to the load detecting connection (LFA) and the load indicating connection (LMA) and that the throttle point (db1) is connected via the annular channel (32) to the load detecting connection (LFB) and the load indicating connection (LMB) to conduct fluid.

6. The valve device according to claim 5, characterized in that the second throttle point (db1) is separated fluid-tight via a sealing part (46) from the central channel (30) with the load indicating connection (LMA) and discharges into a connecting channel (48) to which the annular channel (32) with the load indicating connection (LMB) is connected to conduct fluid.

7. The valve device according to claim 1, characterized in that the fluid connection arrangement (10) in the control housing (12) runs in the following sequence:
control connection (P′A)
user connection (A)
return connection (R)
user connection (B)
control connection (P′B), and
load sensing connection (LS).

8. The valve device according to claim 7, characterized in that the first throttle point (da1) adjacently to the control connection (PA′) projects into the central channel (30) of the valve spool (22) and that the second throttle point (db1) adjacently to the load sensing connection (LS) discharges into the valve spool (22) with limitation of the connection channel (48).

9. The valve device according to claim 1, characterized in that for spring centering of the valve spool (22) two compression springs (24) are used which are located in spring chambers (26, 28) of the device and which in the direction of the connection sites to the pilot valves each have another throttle point (da2, db2).

10. The valve device according to claim 1, characterized in that a compensator (14) which at least partially actuates the fluid connection arrangement (10) concomitantly is connected upstream of the control device (16) with its fluid connections.
